(19) United States
(12) Patent Application Publication
(10) Pub. No.: US 2026/0095028 A1
(43) Pub. Date: Apr. 2, 2026

(54) Aerially Deployable Inflatable Corona Shield for High Voltage Equipment

(71) Applicants: Tristan Tianen Zhang, Pittsford, NY (US); Shibao Zhang, Pittsford, NY (US)

(72) Inventors: Tristan Tianen Zhang, Pittsford, NY (US); Shibao Zhang, Pittsford, NY (US)

(21) Appl. No.: 19/387,562

(22) Filed: Nov. 12, 2025

(51) Int. Cl. H01T 19/04; G05D 1/46; G05D 1/667; H01B 7/40

(52) U.S. Cl. CPC H01T 19/04; G05D 1/46; G05D 1/667; H01B 7/40

(57) ABSTRACT

A deployable corona shielding system for high-voltage equipment is disclosed. The system comprises a flexible corona shield made of polymeric or elastomeric material, configured to be delivered and mounted onto high-voltage electrodes via a remotely operated transportation mechanism such as a drone. The shield may be coated or embedded with conductive materials and optionally layered with dielectric components. A visual or positional detection system guides deployment, while an activation mechanism inflates the shield upon arrival. Engagement and disengagement mechanisms secure the shield and release the transport system. The system supports autonomous operation via onboard sensors and Artificial Intelligence (AI), and may be retrofitted to legacy infrastructure or adapted to environmental and surface irregularities. The corona shielding system may be deployed and adjusted when the high-voltage equipment is either in operation (online) or taken offline. Diagnostic tools may be used to detect residual corona discharge and trigger corrective shielding actions.

### FIELD

The present invention relates to corona shielding systems for high-voltage electrical equipment, specifically to flexible, remotely deployable shielding structures that mitigate corona discharge through adaptive engagement and conductive materials.

### BACKGROUND

Electric power systems rely on high voltage (for example, 10,000 Volts and above) to transmit electricity more efficiently. Corona discharge is a common phenomenon in high-voltage systems, particularly in environments with high humidity, pollution, or surface irregularities. This phenomenon becomes more prominent at higher voltages, such as systems of 230,000 Volts or higher, where the high-voltage electrodes may be meters above the ground and not easily accessible from the ground or by using ladders. Corona discharges lead to energy loss, insulation degradation, electromagnetic interference, and disturbances to nearby residents.

Corona discharge occurs when the electric field on the surface of a high-voltage electrode exceeds the dielectric strength of the surrounding medium such as the ambient air, causing intermittent discharges. A corona shield is electrically connected to the protected high-voltage electrode, so they are at the same potential or voltage. It may have a larger surface area, smoother surface, rounded corners, or a combination of these features to effectively reduce the electric field or stress on the surface to be within the dielectric strength of the surrounding medium, thereby eliminating or mitigating corona discharges. In cases of bad weather, heavy contamination, or voltage spikes, the dielectric strength of the medium around high-voltage electrodes or existing corona shields may decrease, or the electric field may increase, reintroducing corona and necessitating remedial measures.

Traditional corona shields are rigid, manually installed, and often impractical for remote or aging infrastructure. They have predetermined shapes, and in some cases, inner tires of automobiles have been used. Conventional applications require the connected equipment and transmission lines to be taken offline or deenergized to ground the high-voltage electrodes for safe access, resulting in power outages and economic loss. Additionally, adjusting the corona shield requires the system to be taken offline multiple times to verify its effectiveness, which not only increases economic loss but also shortens the equipment's lifespan due to the mechanical and electrical shocks during each offline-online cycle. Furthermore, electric utilities must follow maintenance schedules, which may delay corona elimination and hinder timely verification of effectiveness. For example, if corona discharge occurs only during wet or windy weather, installing a shield on a sunny day may not confirm its effectiveness.

Therefore, there is a need for a flexible, responsive, quick, and easily deployable solution that can adapt to real-world conditions and retrofit existing equipment without interrupting continuous power system operation (e.g., the shield can be used while high-voltage equipment or transmission lines remain energized). The invention can be applied to various high-voltage applications, including transmission lines and equipment such as substations, power transformers, converters, capacitors, and circuit breakers, etc., when the electric power system is still energized.

### SUMMARY

This invention provides a drone-deployable shielding system comprising a flexible balloon or membrane with a conductive outer surface. Upon reaching the target location, the balloon inflates to form a corona shield that redistributes electric field gradients and suppresses discharge. The system supports both proactive and reactive deployment:

A diagnostic tool may be used to detect corona discharge via ultraviolet imaging, acoustic emissions, or visual detection. It can also be detected by analyzing the shape and location of discharge pulses or bands in analog or digital partial discharge or corona discharge curves which is mostly used in the factory environment.

The inflatable corona shield is positioned using a remotely controlled drone or a drone with an Artificial Intelligence (AI) mechanism that automatically executes the process. The shield can be positioned precisely over the affected area to mitigate discharge. This can be done by precisely adjusting the drone's location. A mechanism, such as magnetic or adhesive components, can lock the shield to the high-voltage electrode.

The system is adaptable to environmental deviations (e.g., humidity, wind) and surface irregularities. The inflatable balloon or membrane can adjust its shape by methods such as inflation pressure or repositioning.

It is suitable for retrofitting aging equipment that does not meet current regulatory standards (e.g., IEEE, NEC) or has deteriorated over time. With tightening regulations on allowable corona discharge, aged equipment requires improved or new shielding to comply and protect against damage.

It can also be used during equipment testing, such as transformer factory testing or power substation field testing, as a temporary or permanent remedy for corona discharge. A more permanent corona shield could be developed based on test results and applied to other equipment of the same design to prevent future corona issues.

The application can be executed while the electric power system remains energized and during equipment testing, eliminating the negative effects of shutdowns required by conventional processes. This not only avoids economic loss due to downtime but also increases the reliability of the electric power grid.

In some cases, manned aircrafts could also be used in place of the drones or together with the drones. The application can be also executed when the electric power system is not energized.

### BRIEF DESCRIPTION OF THE DRAWINGS

FIG. 1 shows a conventional rigid corona ring mounted manually on the high voltage electrode atop a power transformer. A second corona ring is shown on a high-voltage divider in the background.

FIG. 2 shows a drone transporting a flexible corona shield toward a high-voltage electrode, including visual detection tools (e.g., camera, GPS) and the engagement mechanism connecting the shield to the electrode.

FIG. 3 displays the corona shields after being deployed on the high-voltage electrodes.

### DETAILED DESCRIPTION

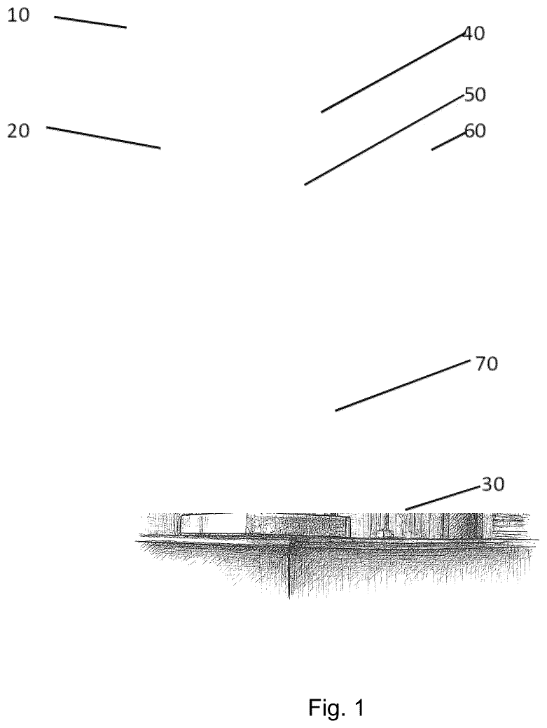

FIG. 1 shows an example of a traditional corona ring 10 on top of high-voltage equipment, namely, a high-voltage bushing 20 atop a power transformer 30. In the background, another corona ring 40 is on top of a high-voltage divider 50. There are also corona shields 60 and 70 shown as examples. These corona rings are typically made of aluminum, are rigid, and must be manually installed by trained operators using ladders or boom lifts.

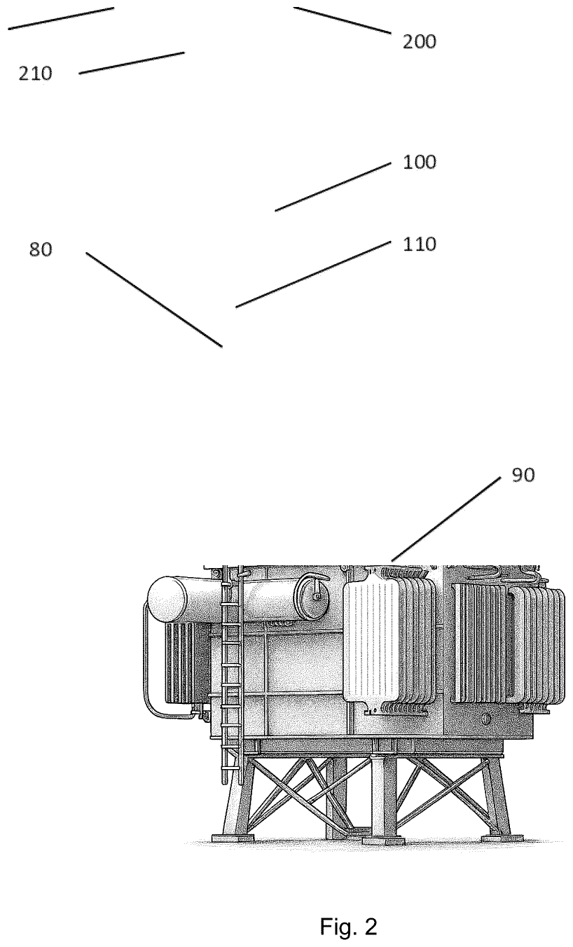

FIG. 2 shows the current shielding system being deployed to a high-voltage electrode 80 of high-voltage equipment 90. The transportation mechanism 200 is remotely controlled by operators or with AI mechanism, and a visual detection tool provides feedback to the operators or AI system regarding the location and position of the transportation mechanism as well as the flexible shielding 100. The engagement structure 110 connects the flexible shielding 100 to the high-voltage electrode 80. The disengagement structure 220 separates the flexible shield from transportation system when being instructed by operators or AI system.

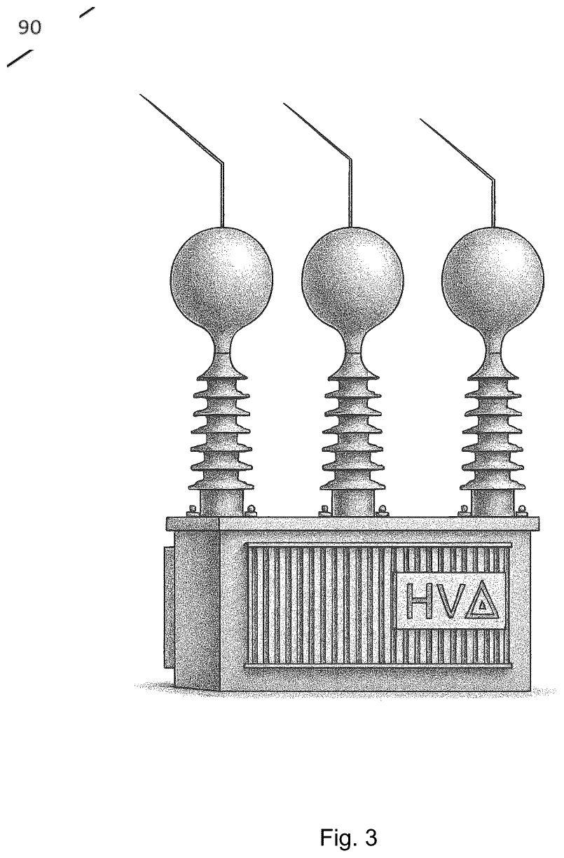

FIG. 3 shows an example after the flexible corona shield 100 is installed on top of the high-voltage electrode 80.

The transportation mechanism 200 is typically a drone, remotely controlled by trained operators or programmed with AI. It may utilize a visual detection tool 210 such as video cameras, infrared scanners or radars, along with GPS sensors and processing systems to detect location and send data back to the operator. Additional tools such as altitude sensors may also be used. The operator can use this information to determine the position of the shielding system and decide the next action. Alternatively, this information may be processed automatically by an AI-integrated control system to determine the next steps, including repositioning, reshaping the shield, or engaging it with the electrode. The AI system may be located onboard or remotely. The shield's position may also be pre-programmed before the actual deployment.

In some cases, manned aircrafts could also be used in place of the drones or together with the drones.

The shielding system includes an engagement tool 110 that locks the shield to the high-voltage electrode 80. This tool may be a magnetic fastener or spring-loaded connector. Alternatively, a remotely controlled or automatically triggered locking system may be used.

Once the shield is engaged with the electrode, the disengagement tool 220 is activated to separate the transport system from the shield. The transport system can then return or move to another designated location, either through remote control or a preset program or AI.

The flexible structure 100 is made of a balloon or membrane composed of polymer or elastomer materials. It may have various shapes and dimensions depending on what it is molded form and the actual inflation pressure. The balloon or membrane may also be twisted or stacked in multiple layers for different applications. It may include an engagement interface 110, such as a magnetic component, to quickly lock it to the high-voltage equipment.

The balloon or membrane may be coated with a conductive material such as carbon nanotubes, metallic mesh, or other nanomaterials. Alternatively, conductive ingredients may be integrated during manufacturing, eliminating the need for a separate coating.

The shield may also include a conductive layer connected to the high-voltage electrode, along with one or more dielectric layers (e.g., silicone rubber or epoxy resin) to address specific conditions such as for reduced clearance or heavy contamination. These dielectric materials offer better resistance to environmental contaminants and help protect the conductive surface.

Once a flexible corona shield is verified to be effective, a permanent flexible or rigid shield may be developed based on the shape and performance of the verified shield and applied to other equipment of the same or similar design.

The system uses a transport mechanism-typically a UAV (drone) equipped with GPS, stabilization, and payload release systems. Alternatives include robotic arms or automated guided vehicles. The balloon or membrane may also be applied manually using insulated rods or robotic arm.

The corona shield can be activated by an onboard gas canister, pneumatic pump, or thermal expansion trigger. If permitted, a small amount of self-explosive material may be used to initiate inflation. The inflation is controlled remotely by operators or remotely or directly controlled by the AI system based on the feedbacks from the performance of the shield.

If corona discharge persists after initial shielding, diagnostic tools (e.g., UV imaging, acoustic, or visual sensors) may be used to locate the source. The drone can then reposition or deploy an additional shield over the affected area.

The system is adaptable to design or environmental deviations. Corona discharge may result from unforeseen surface irregularities (e.g., sharp edges) or environmental factors (e.g., humidity, pollution, wind). The deployed shielding system can also be adjusted with AI mechanism still connected to the shielding. Additional shielding system can be deployed post-installation to patch and mitigate such issues.

This system is also suitable for retrofitting aging equipment that may not meet current standards (e.g., IEEE, NEC) or has deteriorated over time. The balloon shield provides a non-invasive method to improve corona protection without requiring equipment replacement or manual intervention.

Ultraviolet, acoustic, or visual detection tools may be used to locate the corona discharge and determine the initial position of the shield. These tools can also evaluate the shield's effectiveness. In high-voltage lab testing, partial discharge measurement devices may be used to assess corona discharge as part of the system. After deployment, the balloon may remain in place while the drone disengages. It may also be removed if needed.

What is claimed is:

1. A system for deploying a corona shielding apparatus onto high-voltage equipment, comprising:
a flexible corona shield configured to be mounted on a high-voltage electrode, the shield comprising a balloon or membrane formed from a polymeric or elastomeric material;
a transportation mechanism configured to deliver the flexible corona shield to the high-voltage electrode, the transportation mechanism comprising a remotely operated aerial vehicle or robotic device;
an engagement mechanism configured to secure the flexible corona shield to the high-voltage electrode, the engagement mechanism comprising at least one of a magnetic fastener, spring-loaded connector, or remotely actuated locking device;
a detection system comprising at least one of a visual sensor, positional sensor, or ultraviolet imaging device, configured to identify the location of the high-voltage electrode and guide the transportation mechanism;
an activation mechanism configured to inflate or expand the flexible corona shield upon arrival at the high-voltage electrode; and
a disengagement mechanism configured to separate the transportation mechanism from the flexible corona shield after deployment.

2. The system of claim 1, wherein the flexible corona shield comprises a conductive outer surface formed by a coating selected from carbon nanotubes, metallic mesh, or conductive nanomaterials.

3. The system of claim 1, wherein the flexible corona shield comprises conductive ingredients integrated into the material during manufacturing.

4. The system of claim 1, wherein the flexible corona shield comprises a multilayer structure including at least one conductive layer and one dielectric layer selected from silicone rubber or epoxy resin.

5. The system of claim 1, wherein the transportation mechanism could also be manned aircrafts or both remotely operated aerial vehicles and manned aircrafts.

6. The system of claim 1, wherein the transportation mechanism further comprises a GPS module, altitude sensor, and onboard processing unit configured to autonomously determine positioning and navigation.

7. The system of claim 1, wherein the activation mechanism comprises at least one of a gas canister, pneumatic pump, thermal expansion trigger, or micro-explosive inflation device.

8. The system of claim 1, wherein the detection system is further configured to evaluate the effectiveness of the deployed corona shield using ultraviolet imaging, acoustic sensors, or partial discharge measurement tools.

9. The system of claim 1, wherein the transportation mechanism is configured to deploy additional flexible corona shields in response to detection of residual corona discharge.

10. The system of claim 1, wherein the flexible corona shield is pre-molded or pressure-shaped to conform to a predetermined geometry of the high-voltage electrode.

11. The system of claim 1, wherein the transportation mechanism is configured to operate autonomously using Artificial Intelligence (AI) to determine deployment position, shield configuration, and engagement timing.

12. The system of claim 1, wherein the flexible corona shield is configured to remain in place after deployment or be removed by the transportation mechanism.

13. The system of claim 1, wherein the system is configured for retrofitting legacy high-voltage equipment to improve corona shielding without requiring equipment replacement.

14. The system of claim 1, wherein the flexible corona shield is configured to adapt to environmental deviations including humidity, pollution, wind, or surface irregularities.

15. The system of claim 1, wherein the transportation mechanism comprises an unmanned aerial vehicle (UAV), robotic arm, or automated guided vehicle.

16. The system of claim 1, wherein the flexible corona shield is deployable and adjustable without taking the high-voltage equipment offline.
